(19) United States
(12) Patent Application Publication
(10) Pub. No.: US 2014/0049161 A1
(43) Pub. Date: Feb. 20, 2014

(54) INSTANT START BALLAST SYSTEM

(71) Applicants: Yuhong Fang, Naperville, IL (US); Arun Ganesh, Aurora, IL (US)

(72) Inventors: Yuhong Fang, Naperville, IL (US); Arun Ganesh, Aurora, IL (US)

(73) Assignee: KONINKLIJKE PHILIPS N.V., EINDHOVEN (NL)

(21) Appl. No.: 14/113,073

(22) PCT Filed: Apr. 16, 2012
(86) PCT No.: PCT/IB2012/051874

§ 371 Date: Oct. 21, 2013

Related U.S. Application Data
(60) Provisional application No. 61/478,088, filed on Apr. 22, 2011.

(51) Int. Cl. H05B 41/36

(52) U.S. Cl. CPC H05B 41/36
USPC 315/106

(57) ABSTRACT

A program-start ballast (100) that is connectable to a lamp (150) with a filament (151) is disclosed. The ballast includes a heating unit (170) arranged to heat the filament (151), a receiver (180) arranged to receive a signal to turn the lamp (150) on or off, and a control circuit (160) arranged to turn the lamp (150) on or off based upon an output of the receiver (180). The heating unit (160) is further arranged to heat the filament (151) before the signal to turn the lamp on is received by the receiver (180) and keep the filament (151) heated after the signal to turn off the lamp is received by the receiver (180).

### BACKGROUND OF THE INVENTION

1. Field of the Invention

The present invention relates to electronic ballasts and more particularly to a program-start ballast including an occupancy signal receiver and heating controller that provides constant heating to lamp filaments to allow for quick start.

2. Description of the Related Art

Electronic lamp ballasts use solid state electronic circuitry to provide the proper starting and operating electrical condition to power one or more fluorescent lamps and/or high-intensity discharge (HID) lamps. In addition, high-efficiency, high frequency electronic ballasts are known to offer superior lighting performance and energy savings making their use cost-effective. Electronic ballasts are available in fixed light, as well as full range dimming models.

A first major category of electronic ballasts are instant-start ballasts. Conventional instant start ballasts start lamps without heating the cathodes of the lamps by using high voltage (around 600 volts). Such conventional instant start ballasts are one of the most energy efficient types of electronic ballasts. However, a drawback of such instant start ballasts is that they provide the least number of starts from a lamp. This is because emissive oxides are blasted from the cold cathode surfaces each time the lamp is started which shorten the life of the lamp. This type of conventional ballast is the best used installations where lamps are not turned on and off very often.

FIG. 1 shows a conventional electronic fluorescent instant start ballast system 10. The ballast includes an electromagnet interference (EMI) filter 20, bridge diodes (D1-D4), power factor correction (PFC) converter 30, an inverter 40 and one or more lamps 50. When an input voltage is applied to the inputs of the ballast system 10, it starts the lamps 50 instantly without preheating the filaments of the lamps 50. The switching life of the lamps 50 is about 2000-8000 cycles.

A second major category of ballasts are program-start ballasts. The conventional program-start ballast is a more advanced version of a rapid start ballast. The conventional program-start ballast applies power to the filaments of the lamps first, then after a short delay (to allow the cathodes to preheat), applies voltage to the lamps to strike an arc. Such conventional program-start ballasts give the best life and most starts from the lamps. Because of this, program-start ballasts are preferred for applications that require very frequent power cycling such as medical examination rooms and restrooms with a motion detector switch.

FIG. 2 shows a conventional electronic fluorescent program start ballast system 11. The ballast system 11 includes an EMI filter 21, bridge diodes (D1-D4), a PFC converter 31, an inverter 41, preheat circuitry 61, a controller 71 and one or more lamps 51. The lamps 51 can be connected in series or parallel. As shown in FIG. 2, the lamps 51 are connected in parallel. The common connection of one or more filaments 52 of the lamps 51 (i.e., right side of the lamps 51) could be in series or in parallel. As shown in FIG. 2, the filaments 52 are in parallel.

As noted above, the conventional program-start ballasts preheat the filaments of the lamps before ignition. This allows the lamps to have a longer switching life. The preheat time can take about 0.5-1.5 seconds depending on the design. The lamp switching life can reach more than 50,000 cycles. In contrast, as noted above, the switching life of lamps that use the instant-start ballasts, which provide high voltage to ignite lamps instantly without preheating filaments, is much shorter and can only reach 2000-8000 cycles.

In addition, for energy saving purposes, lighting systems are known to use occupancy sensors (not shown in FIG. 2) to turn the light on/off depending on whether there are people in the sensing area. The signal from such occupancy sensors are used by a control circuit external to the ballast system to switch the input power ON/OFF. When a person enters the sensing area, the occupancy sensor sends a signal to the control circuit that turns on (i.e., connects) the input power. However, there is always a time delay before the light is turned on which is not desirable.

For example, in Japanese Patent Abstract, publication number 10-134966, a fluorescent lamp luminaire is provided with a human body sensor. A controller is used to change the load of the fluorescent lamp (i.e., turn on) in response to the detection of a person by the sensor. As understood by Applicants, when a person is first detected, the filaments of the fluorescent lamp must be preheated (causing a delay) before the fluorescent lamp goes on. When the person leaves the vicinity of the sensor, the controller removes the load (i.e., turns the fluorescent lamp off) and places the luminaire in a standby mode. The standby mode may be a preheating condition or an off condition (no preheating). The preheating condition allows for the fluorescent lamp to turn on quickly if a person returns to the vicinity. The off condition requires the fluorescent lamp to preheat again before turning on when a person returns to the vicinity. However, in both standby modes, preheating must be performed at least the first time a person enters the vicinity.

In lighting systems that require the electronic ballast to turn on and off frequently, the light should turn on instantly or with very short time delay and this should also not shorten the lamp life. While conventional program start ballasts, as discussed above, can meet the second requirement and conventional instant start ballasts can meet the first requirement; an electronic ballast that meets both requirements is not known in the art.

Accordingly a need exists in the art of an electronic ballast that address the shortcomings of the conventional electronic ballasts described above.

### BRIEF SUMMARY OF THE INVENTION

The present invention provides for an instant start ballast system that does not shorten the switching life of the lamps as compared to conventional program state ballast systems.

In this regard, one aspect of the present invention presents electronic ballast that can quickly start fluorescent lamps with heated filaments. The lamps are driven by the inventive ballast system that can be turned on/off in accordance with an occupancy signal or other switching devices. However the lamp's filaments are kept heating during the off time. When the lamps need to be turned on, the ballast system ignites the lamps instantly. Since the filaments of the lamps are heated during the off time, the lamp switching life will not be shortened. The inventive ballast system meets both instant start and long switching life requirement.

One aspect of the present invention is related to a ballast that is able to be coupled to one or more lamps that each having a filament. The ballast includes an inverter that can be connected to the lamps and a heating circuit also connected to the lamps and arranged to keep the filament of each lamp at a constant state of heating. The ballast also includes a controller connected to the inverter and the heating circuit and a signal receiver connected to the heating circuit. Based upon an output from the signal receiver, the controller causes the lamp to turn on or off.

Another aspect of the present invention is related to a method for turning on a fluorescent lamp. the method includes the steps of when input power is applied to the fluorescent lamp, heating filaments of the fluorescent lamp and after the input power is applied when a first signal is received indicating to turn on the fluorescent lamp, turning on the fluorescent lamp . The method also includes the steps of when a second signal is received indicating to turn off the fluorescent lamp, turning off the fluorescent lamp and when the fluorescent lamp is turn off based upon the second signal, maintaining the heating of the filaments.

Yet another aspect of the present invention is related to a ballast with a connection to couple to at least one lamp with a filament. The ballast includes a heating unit arranged to heat the filament, a receiver arranged to receive a signal to turn the lamp on or off, and a control circuit arranged to turn the lamp on or off based upon an output of the receiver. The heating unit is further arranged to (1) heat the filament before the signal to turn the lamp on is received by the receiver and (2) keep the filament heated after the signal to turn off the lamp is received by the receiver.

One object of various embodiments of the present invention is to start a fluorescent lamp instantly or with very short time delay.

Another object of various embodiments of the present invention is directed to a ballast that improves the switching life of lamps as compared to conventional program-start ballasts.

Yet another object of various embodiments of the present invention is directed to a ballast that is useful in lighting systems that require the ballast to turn on and off frequently in that lamps in the lighting system should turn on instantly or with very short time delay and this should also not shorten the lamp life.

The foregoing embodiments and other embodiments of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 shows a conventional electronic fluorescent instant start ballast system.

FIG. 2 shows a conventional electronic fluorescent program start ballast system.

FIG. 3 shows a ballast system in accordance with one embodiment of the present invention.

FIG. 4 shows a ballast system in accordance with second embodiment of the present invention.

FIG. 5 shows a ballast system in accordance with another embodiment of the present invention.

FIG. 6 shows a ballast system in accordance with yet another embodiment of the present invention.

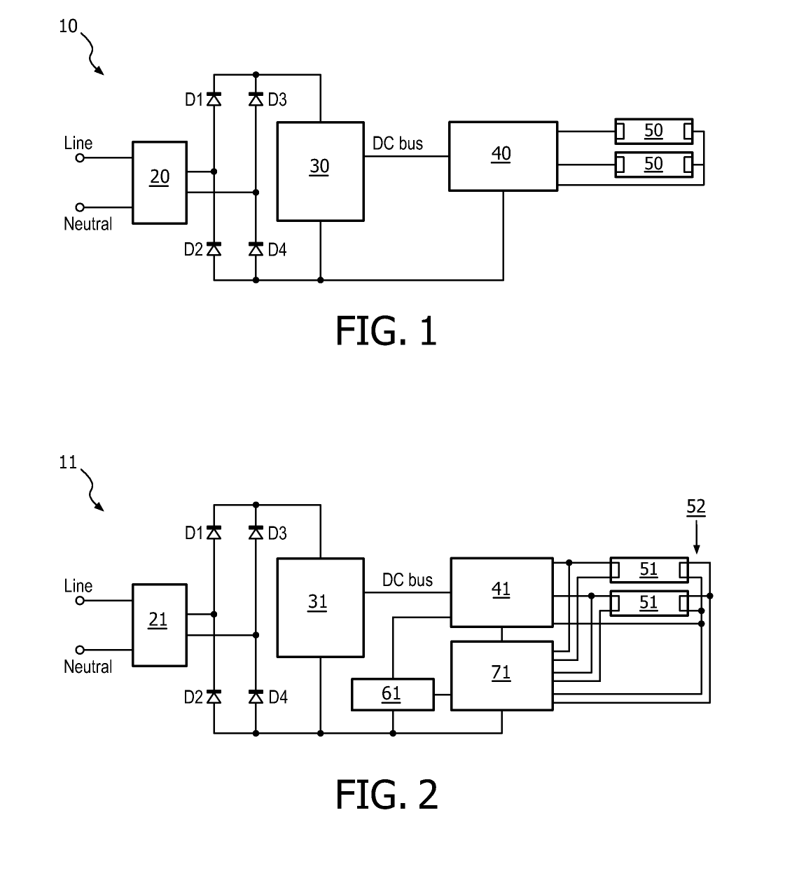

### DETAILED DESCRIPTION OF THE INVENTION

The following description is of the best-contemplated modes and embodiments of implementing the present invention. This description is made for the purpose of illustrating the general principles of the invention and should not be taken in a limiting sense. The scope of the invention is best determined by reference to the appended claims.

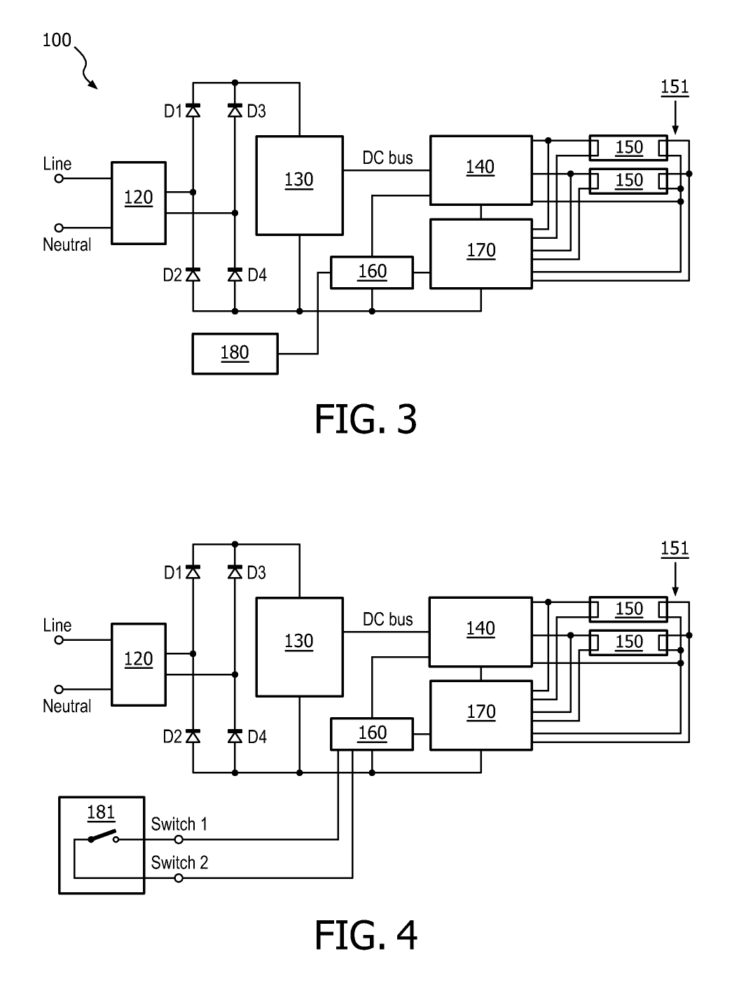

FIG. 3 is diagram of the ballast system 100 according to a first embodiment of the present invention. The system 100 includes an EMI filter 120, bridge diodes (D1-D4), a PFC converter 130, an inverter 140, heating circuitry 160, a controller 170 and one or more lamps 150. The lamps 150 can be connected in series or parallel. As shown in FIG. 3, the lamps 150 are connected in parallel. The common connection of one or more filaments 151 of the lamps 150 (i.e., right side of the lamps 150) could be in series or in parallel. As shown in FIG. 3, the filaments 151 are in parallel.

In contrast to the conventional program start ballast system 11 shown in FIG. 2, there is an occupancy signal receiving unit 180 coupled to the heating controller 160 in the ballast system 100. The heating controller 160 replaces the conventional controller 61 and the heating circuitry 170 replaces the conventional preheating circuitry 71. The heating controller 160 is arranged to keep the filaments 151 of the lamps 150 at a constant state of heating using the heating circuitry 170 (as soon as power is provided to the ballast system 100).

In the ballast system 100, one feature therein is that the occupancy signal receiving unit 180 is not switching on/off the input power directly. When the occupancy signal receiving unit 180 does not receive a signal that people present in the area, the occupancy signal receiving unit 180 sends a signal to the heating circuitry 170 to turn off the lamps 151. However, as noted above, the heating controller 160 keeps the filaments 151 heating. When occupancy signal receiving unit 180 receives a signal that people are in the area, the occupancy signal receiving unit 180 sends a signal to the heating controller 160 to ignite the lamps 150 instantly. Since the filaments 151 are kept heated during off time, switching life of lamps is not shortened. Accordingly, the ballast system 100 meets both requirements noted above of frequently instant ON/OFF switching and long switching life.

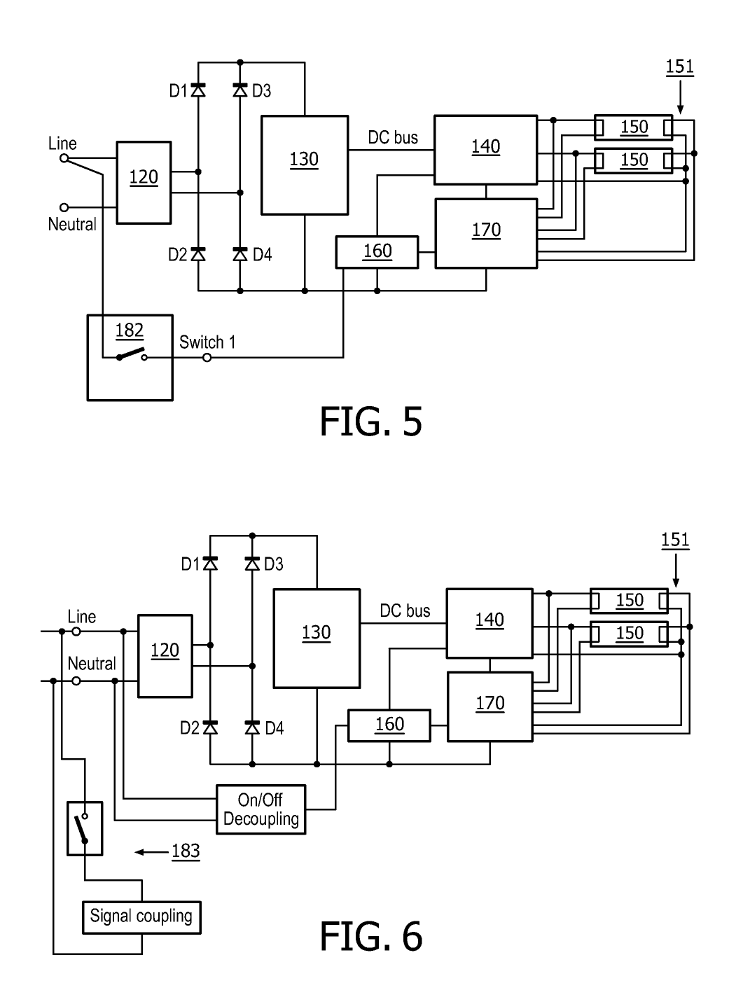

Another aspect of the present invention is that the occupancy signal receiving unit 180 can be implemented through different ways. In the embodiment shown in FIG. 4. a two wire configuration using a sensor 181 is shown. In the embodiment shown in FIG. 5, a one wire configuration using a sensor 182 is shown. In the embodiment shown in FIG. 6, a power line coupling using a sensor 183 is shown. In yet another embodiment, wireless receiver/transmitter (not shown) may be used.

As will be appreciated by one of ordinary skill in the art, the respective embodiments noted above have various uses and advantages. For example, the two wire configuration shown in FIG. 4 can be easy isolated from the control wires to the system 100. The one wire configuration shown in FIG. 5 is not as easily isolated as compared to the two wire configuration, but only has one additional wire for manufacturing and installation. The power line coupling configuration shown in FIG. 6 has no additional wires, is easier for end-users/customers to install, but it is more difficult to design and has a higher manufacturing cost as compared to the embodiments shown if FIGS. 4 and 5

As will be understood by one skilled in the art, the various embodiments discussed above allow for the occupancy signal receiving unit to be able to receive various types of signal (digital “1” or “0”; ground, line voltage, etc) that may be used to control (turn on/off) the lamps 150. The occupancy signal receiving unit 180 is preferably adapted to receive signals directly from an external sensor. Accordingly, according to this aspect of the present invention, raw signals from the external sensors are substantially independent of any further signal conditioning.

The ballast system 100 is not limited to only one type of implementation for the occupancy signal receiving unit 180, but multiple configurations may be used (in the ballast system 100) to provide flexibility to couple with different types of sensors. In one preferred embodiment, the occupancy signal receiving unit is integrated with the ballast system 100. This is in contrast to the conventional occupancy sensors discussed above that are used to couple/decouple the input power that require additional control circuitry (external to the ballast) to couple/decouple the input power.

Referring to FIGS. 3-6, those having ordinary skill in the art will appreciate the numerous advantages of the present invention for an improved ballast system design. It should also be understood that the various elements of the ballast system 100 as shown in FIG. 3 can be implemented in different way or different circuit: analogue circuitry or microcontroller based digital circuitry; the inverter 140 can have a different topology such as integrated driven half bridge or self oscillation half bridge. The heating circuitry 170 can be separated from the inverter 140 or be coupled to some components of the inverter 140 such as resonant inductor (not shown).

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

1. A ballast coupled at least to a lamp having a filament, the ballast comprising:
an inverter coupled to a DC bus and the lamp for providing power to the lamp;
a heating circuit coupled to the lamp and the inverter to keep the filament at a constant state of heating;
a controller coupled to the inverter and the heating circuit for controlling the heating circuit to heat the filament when the lamp is OFF; and
a signal receiver coupled to the controller for indicating when the lamp is OFF and when to turn the lamp ON.

2. The ballast according to claim 1, wherein the signal receiver is an occupancy sensor.

3. (canceled)

4. (canceled)

5. (canceled)

6. The ballast according to claim 1, wherein the signal receiver is integrated in the ballast and comprises a two wire switch.

7. The ballast according to claim 1, wherein the signal receiver is integrated in the ballast and comprises a one wire switch.

8. The ballast according to claim 1, wherein the signal receiver is coupled to an input power line.

9. The ballast according to claim 8, wherein the signal receiver further comprises a wireless ON/OFF decoupling.

10. The ballast according to claim 5, wherein the lamp is a fluorescent lamp.

11. A method for turning on a fluorescent lamp having a filament, the method comprising the acts of:
providing input power to the fluorescent lamp;
after the input power is applied
in response to receiving a signal directing to turn lights OFF, turning the fluorescent lamp (150) OFF and keeping the filament of the fluorescent lamp (150) at a constant state of heating; and
in response to receiving a signal directing to turn lights ON, turning the fluorescent lamp (15) ON,
wherein the signal is received from a sensor.

12. A ballast coupled at least to a lamp having a filament, the ballast comprising:
a heating unit coupled to the lamp to keep the filament at a constant state of heating;
a switch configured to provide an indication when to turn the lamp ON/OFF; and
a control circuit coupled to the switch for receiving the indication and configured to:
when the indication is to turn the lamp OFF, control the heating unit to heat the filament, and
when the indication is to turn the lamp ON, turn the lamp ON.

13. The ballast according to claim 12, wherein the heating unit is configured to keep the filament heated after the signal to turn the lamp OFF is received.

14. (canceled)

15. (canceled)

16. The ballast according to claim 13, wherein the switch is integrated in the ballast and wherein the signal is one of a digital signal and an analogue.

17. The ballast according to claim 13, wherein the switch comprises a two wire input configuration switch.

18. The ballast according to claim 13, wherein the switch comprises a one wire input configuration switch.

19. The ballast according to claim 13, wherein the switch comprises an input power line coupling configuration switch.

20. The ballast according to claim 19, wherein the switch is wireless.
